(19) United States
(12) Patent Application Publication
(10) Pub. No.: US 2002/0090080 A1
(43) Pub. Date: Jul. 11, 2002

(54) Loop voltage detection circuit

(75) Inventor: Paul Michael Tiernan, Walkhampton (GB)

Correspondence Address: LAW OFFICE OF LAWRENCE E LAUBSCHER, JR, 1160 SPA RD, SUITE 2B, ANNAPOLIS, MD, 21403, US

(73) Assignee: Zarlink Semiconductor Inc., Kanata (CA)

(21) Appl. No.: 10/003,584

(22) Filed: Nov. 26, 2001

(30) Foreign Application Priority Data
Nov. 30, 2000 (GB) 0029178.1

(51) Int. Cl. H04M 1/00; H04M 9/00

(52) U.S. Cl. 379/412; 379/399.01

(57) ABSTRACT

A system and a method are described for detecting the line status (on-hook/off-hook) of a telephone terminal connected in parallel with a second communications terminal at a customer premises using a loop voltage detection circuit. The telephone terminal and second communications terminal being connected to the Public Switched Telephone Network (PSTN). The system detects a transition on Tip with respect to Ring on a telecommunications transmission line and ensures that the transition is of sufficient duration before providing an output. The system will ignore glitches, transient open circuits, TIP/RING polarity reversal, TIP ground and/or RING ground and Ringing. The system will detect line status for positive or negative TIP/RING polarity.

This invention relates to a method and apparatus for a parallel telephone on/off hook detection for customer premises equipment using a loop voltage detection circuit. This invention is suitable for, but not limited to a Data Access Array (DAA), interfacing to a local exchange. The invention detects a transition on Tip with respect to Ring on a telecommunications transmission line, but also ensures that the transition is real and not an undesired glitch, before providing an output.

The following text describes how the invention will work if used in a DAA application when connected to a local exchange. The present invention will hereinafter be referred to as a Loop Voltage Detection circuit (LVD). It can form part of the loop supervision function of a Data Access Array (for example: the Mitel MT91634 used in conjunction with the Mitel MT91633 to provide a Data-Access Array (DAA) solution.)

The invention presents termination to any telephone line conforming to standard telecom protocols in most countries throughout the world. The DAA solution would be used in central office telephone exchange applications, set-top boxes in the home or in fax machines or modems.

The intention of the Loop Voltage Detection circuit is to provide a logic output that can be used to detect whether a telephone connected in parallel to the DAA solution has been taken off-hook. This would cause an alteration to the load presented to the telecom line. Generally the line is supplied by a Subscriber Line Interface Circuit (SLIC) which will be constant current, so as the load is reduced by the parallel phone the voltage connected across TIP and RING must also reduce to maintain the same current.

There are some requirements from telecom service provider companies to ignore certain conditions on the line that can occur naturally or be forced by the company. The worst case condition known is that the line can be taken open-circuit for up to 200 ms and the equipment attached to the line should ignore any glitches in the DC voltage caused by this phenomena. The Loop Voltage Detection circuitry should ignore any changes in line voltage less than 200 ms, but provide a pulse for any change in line voltage longer than this period. There are other conditions that occur on the line (or loop) such as TIP/RING polarity reversal, TIP ground and/or RING ground and Ringing. None of these conditions should cause a pulse on the Loop Voltage Detect output. It should be noted that the polarity of TIP/RING can be reversed, and the line voltage change must be detected in both polarities.

According to the present invention, there is provided a system for detecting line status of a telephone terminal in parallel with a second communications terminal at a customer's premises, the telephone and second terminal being connected to the Public Switched Telephone Network (PSTN). The system comprising a DC isolation barrier isolating the PSTN and the telephone from the second terminal; means in the isolation barrier to transfer an analogue representation of voltage values received from the PSTN to a loop detection circuit and detection means in said loop detection circuit: to detect a transition in the analogue representations having a duration greater than a selected value.

The invention also provides a system for detecting off-hook status of a telephone connected in parallel with a data transmission terminal at a customer's premise, the telephone and the data transmission terminal being connected to the Public Switched Telephone Network (PSTN). The system comprising a DC isolation barrier isolating the PSTN and the telephone from the data terminals connected in parallel; means in the isolation barrier to generate an analogue representation of Tip and Ring voltage values received from the PSTN; means to pass the analogue representation to a downstream loop detection circuit and detection means in said loop detection circuit to detect a transition in the analogue representation having a duration greater than a selected value wherein a transition in the analogue representation having a duration greater than said selected value indicates that said telephone has gone off-hook.

The invention further provides a method of detecting line status of a telephone terminal connected in parallel with a second communications terminal at a customer's premise, the telephone and second terminal being connected to the Public Switched Telephone Network (PSTN). The method comprising the steps of providing a DC isolation barrier isolating the PSTN and the telephone from the second terminal; generating in the isolation barrier an analogue representation of voltage values received from the PSTN; transferring the analogue representation to a loop detection circuit and detecting, in said loop detection circuit, transitions in the analogue representations having a duration greater than a selected value.

The invention will now be described in detail, by way of example only, with reference to the accompanying drawings, in which:

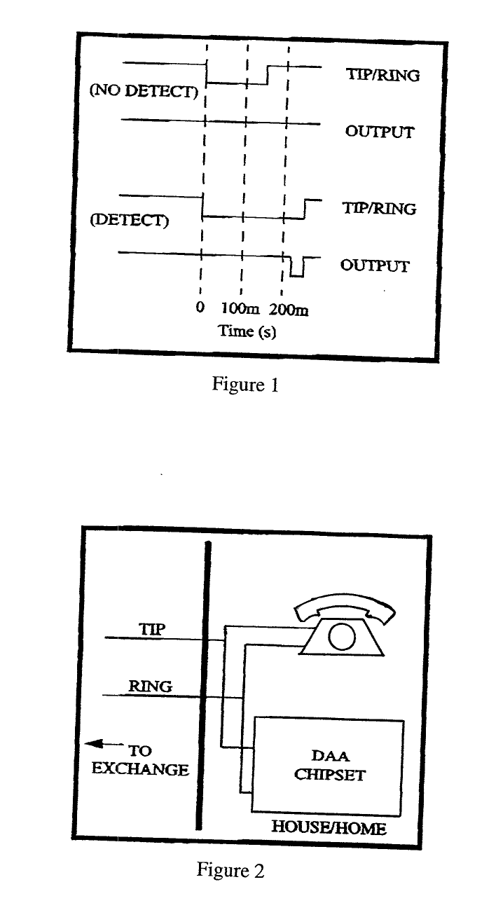

FIG. 1 is a timing diagram showing Tip/Ring transitions that are detected and are not detected by the present invention;

FIG. 2 shows an arrangement of the present invention in a telephone subscriber loop in conjunction with a data access arrangement;

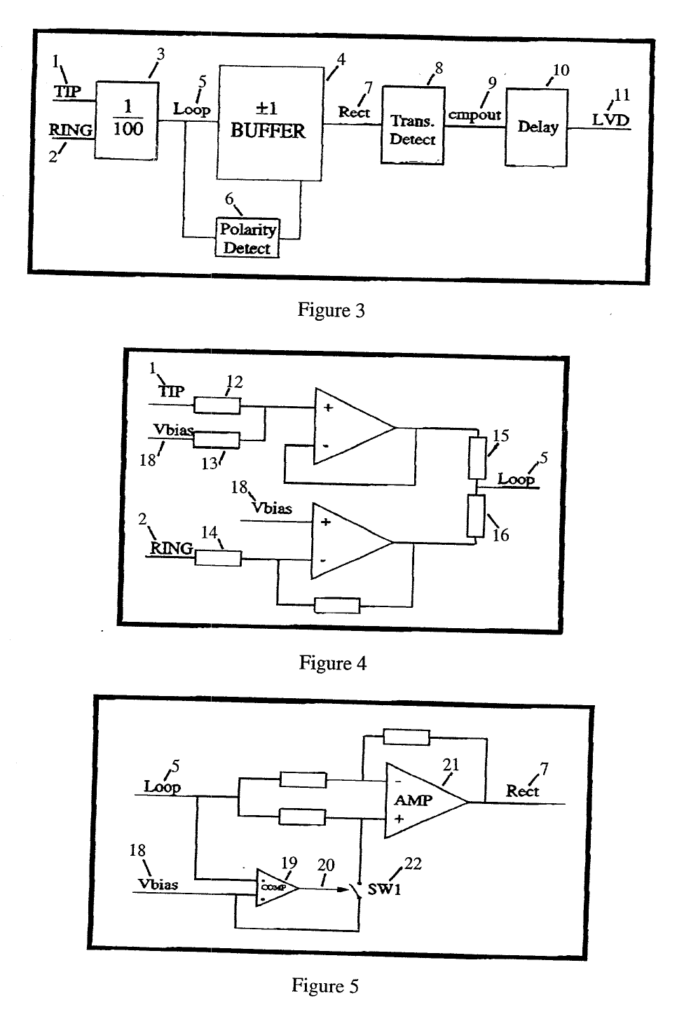

FIG. 3 shows a block diagram representation of the present invention;

FIG. 4 shows a schematic representation of the DC isolation barrier portion of the present invention;

FIG. 5 shows a schematic representation of the line polarity reversal detection portion of the present invention;

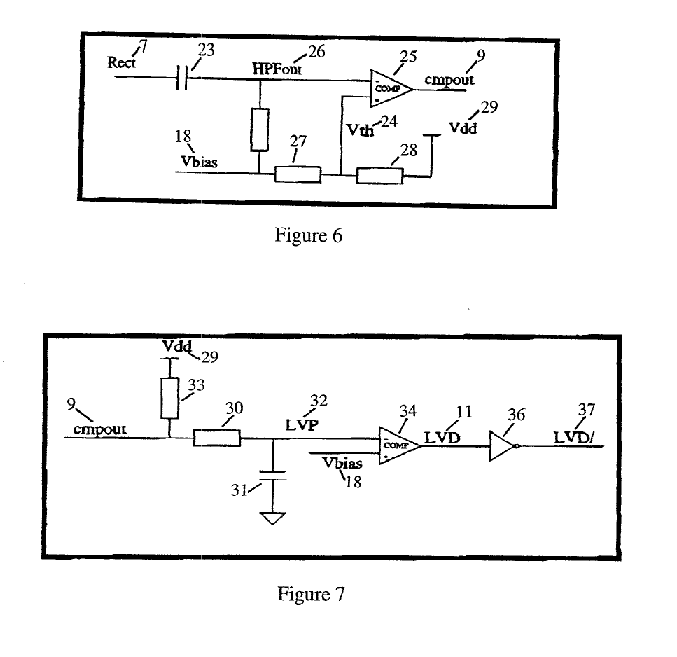

FIG. 6 shows a schematic representation of the loop voltage transition detection portion of the present invention;

FIG. 7 shows a schematic representation of the transition detection time delay portion of the present invention;

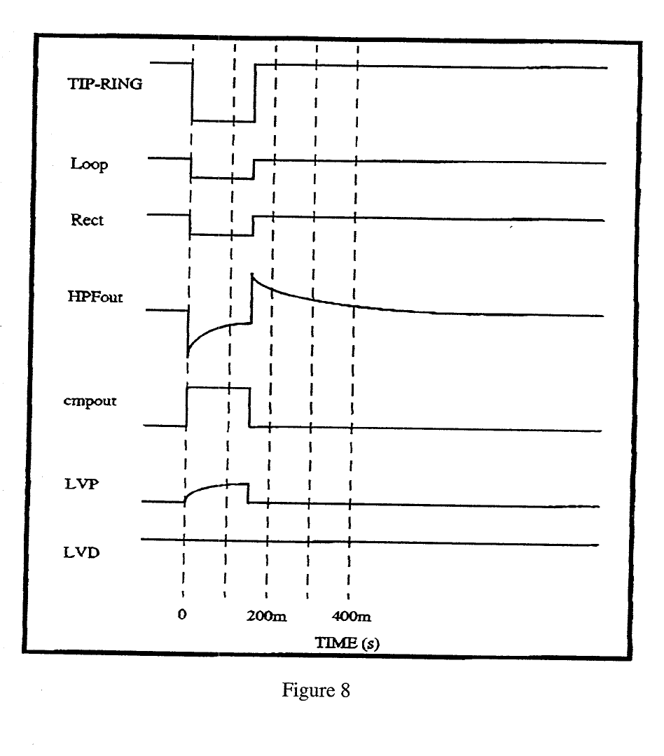

FIG. 8 is a timing diagram showing the analogue waveform shapes of the signals within the present invention under the condition where the voltage at TIP with respect to RING is changed for less than 200 ms;

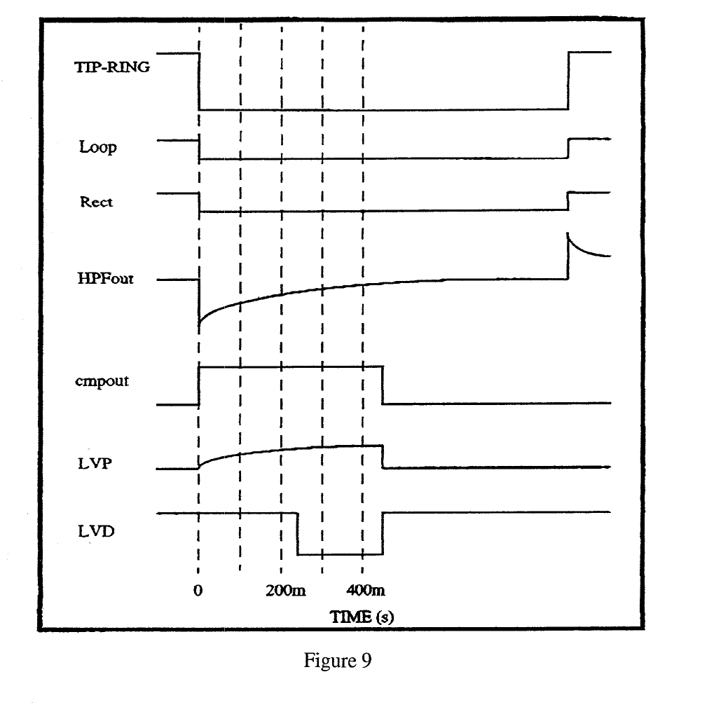

FIG. 9 is a timing diagram showing the analogue waveform shapes of the signals within the present invention under the condition where the voltage at TIP with respect to RING is changed for longer than 200 ms; and

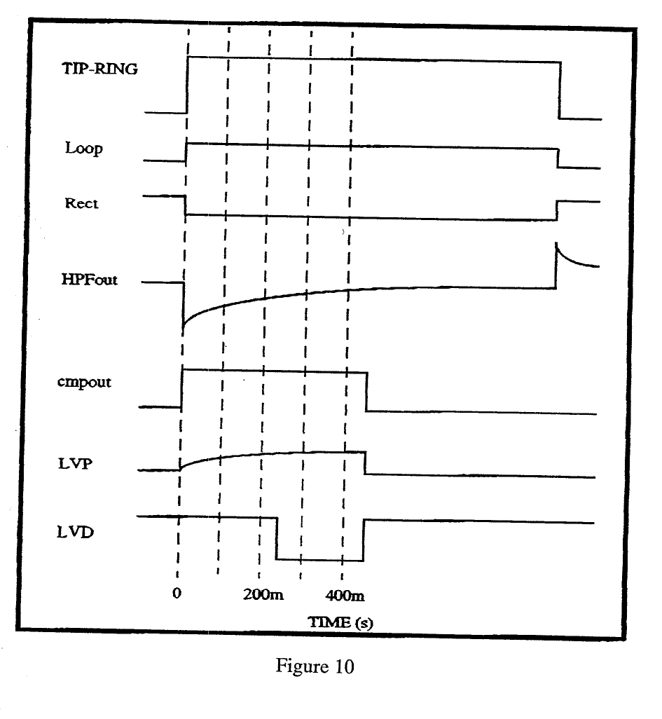

FIG. 10 is a timing diagram showing the analogue waveform shapes of the signals within the present invention under the condition where the voltage at TIP with respect to RING is changed for longer than 200 ms and the polarity of TIP with respect to RING has been reversed.

The block diagram in FIG. 3 illustrates how the system detects if a transition occurs on the Loop created by TIP 1 and RING 2. The signal from TIP/RING is divided by 100 while crossing an isolation barrier 3. This is explained in more detail later in the document. The Loop output from this block is used to supply the buffer 4 with a representation of the signal on TIP/RING 5, plus the means 6 to determine the polarity of the signal. The buffer 4 then changes the polarity if necessary for a single orientation of polarity at Rect 7. The Trans. Detect block 8 looks for a transition in the DC voltage of the Rect signal and outputs a pulse at cmpout 9 accordingly. If the pulse is of duration less than 200 ms, the Delay block 10 maintains the state of LVD 11. Where a pulse of duration longer than 200 ms is detected at cmpout 9, the Delay block 10 forces LVD 11 to change state, indicating a parallel phone has been taken off-hook.

There is a requirement for a DC isolation barrier to be placed between the line side and the equipment side of the DAA, where less than 10 μA of DC current flows with 100V of DC potential applied to TIP and RING simultaneously with respect to the equipment ground. The barrier is also required to withstand 1500 Vrms (60 Hz) for 1 minute without causing any damage to the external components or the silicon.

The initial task is to get a representation of the DC voltage on TIP 1 with respect to RING 2 across the DC isolation barrier. As the specification states that with 100 Vdc applied, the barrier should see no more than 10 μA of DC current flowing, it is possible to fit resistors 12, 14 in the barrier providing the total combined DC resistance is greater than 10 MegaOhms. This method is used to pass DC current across the barrier and obtain the representative signal. In the example shown, two resistors 12, 14 of 22 Megaohms are used but any resistor values can be utilised for future iterations of this product providing the resultant DC resistance is greater than 10 MegaOhms.

The circuit in FIG. 4 shows that TIP 1 and RING 2 are both divided by a ratio, and then averaged through two resistors 15, 16 to obtain a single dc level 5 superimposed on a central bias voltage 18. The dc level 5 changes in direct proportion to the voltage on TIP 1 with respect to RING 2 divided by half the ratio. A ratio of 0.02 is chosen to be suitable for this particular application but any division is possible depending on the application to be used. This particular ratio allows TIP 1 and RING 2 to be taken to almost 100V with respect to ground and still have a useful dynamic range at Loop 5 for other applications in the circuit such as ringing detection. As a result, extremes of battery voltage around the world should be within the design limits of this product.

If a parallel phone is taken off-hook the total impedance presented to the line is reduced, therefore TIP 1 will always reduce with respect to RING 2, never increase. If the line polarity can be detected it is possible to use a plus or minus one gain stage and hence ensure that for either polarity, the voltage to detect always changes in the same direction.

It can be seen from the circuit in FIG. 4 that while TIP 1 is more positive than RING 2, the Loop 5 output voltage will always be more positive than Vbias 18. Conversely if TIP 1 is more negative than RING 2 in the reverse polarity condition, the Loop 5 output voltage will always be less than Vbias 18. Using a comparator 19 it is possible to provide a logic output 20 where a logic low indicates a Forward Loop condition and a logic high indicates a Reverse Loop condition. This comparator 19 can then be used to drive an inverting/non-inverting amplifier 21 depending on the polarity as shown in FIG. 5.

If Loop 5 is more positive than Vbias 18, the I comparator output is low, ensuring switch SW1 22 is open and Rect 7 is a function of Loop 5 multiplied by a positive gain. If Loop 5 is negative with respect to Vbias 18, the switch SW1 22 is closed and Rect 7 becomes a function of Loop 5 multiplied by a negative gain. The polarity reversal is therefore eliminated at Rect 7. The current design has an amplification of +/−1 but any amplification could be used depending on the application. The switch 22 can be made up of MOSFET transistors or any other circuit providing current can flow in both directions when the connection is closed.

The next process is to detect a negative transition in the TIP 1 voltage with respect to RING 2. This would correspond to a negative transition in the Loop 5 voltage, and hence a negative transition in the Rect 7 voltage. There is no need to detect DC potential, so passing the Rect 7 signal through a high-pass filter 23 will block DC and provide a spike whenever a transition occurs. A new reference potential Vth 24 is provided on the other side of the filter 23 and a comparator 25 used to detect the spike superimposed on the reference potential 24. This is illustrated in FIG. 6, where the spike associated with the transition on Rect 7 will appear at HPFout 26, superimposed on Vbias 18. The detection threshold is set by the two resistors 27, 28 on either side of Vth 24. Vth 24 should be set as close to Vbias 18 as possible to detect the smallest transitions, but far enough away to prevent false triggering due to noise or unwanted signals. It is likely that a large audio signal, and definite that a ringing signal placed on TIP 1 with respect to RING 2 will cause this comparator 25 to trigger, but this is not an issue due to the next stage.

The comparator 25 has been designed with an open collector output in order to facilitate the design of the next stage. As a result, for normal operation the comparator 25 causes cmpout 9 to be grounded, and when a transition occurs, the comparator 25 presents a high impedance to cmpout 9. For this application Vth 24 is set to just under 1% above Vbias 18 of the total voltage from Vbias 18 to Vdd 29.

FIG. 7 shows the final stage of the detection circuit. In normal operation cmpout 9 is grounded by the comparator 25 output. Current flows through the series resistor 30 until the capacitor 31 connected to LVP 32 is discharged.

When a transition occurs the comparator 25 presents a high impedance to cmpout 9. The discharged capacitor 31 begins charging with current sourced through the large pull-up resistor 33 and the series resistor 30. The value of the pull-up resistor 33, the series resistor 30 and the capacitor 31 determine the rate of charge (the input to the comparator 34 connected at LVP 32 is high impedance).

As the capacitor 31 charges, LVP 32 increases towards Vbias 18 and will eventually trip the comparator 34. The detection time can be altered by changing the capacitor 31 value or either of the resistors 30, 33. The current application is optimised so the end-user can program the detection time by simply changing the capacitor 31 value, where the default design is to require at least 200 ms before the comparator 34 is triggered. If the transition is less than 200 ms, the comparator 25 immediately grounds cmpout 9, and the capacitor 31 is speedily discharged through the series resistor 30. This ensures compliance with the requirements of telecom service providers described in the introduction. The inverter 36 is required to obtain LVD/37.

Timing diagrams for the complete circuit are shown in FIGS. 8, 9 and 10. The timing diagrams show the timing and analogue waveforms shapes of the circuits described above. The waveforms are not drawn to scale, but are a representation to assist in the understanding of the circuit operation.

In FIG. 8, the voltage at TIP with respect to RING (TIP-RING) is changed for less than 200 ms and no pulse is presented at LVD.

In FIG. 9, the voltage at TIP with respect to RING (TIP-RING) is changed for longer than 200 ms and a pulse is presented at LVD.

In FIG. 10, the polarity of TIP with respect to RING has been reversed and voltage at TIP with respect to RING (TIP-RING) is changed for longer than 200 ms. A pulse is presented at LVD.

There may be certain signals on the telecom line that will trigger the comparator 25 in FIG. 6, but due to the delay it is unlikely that any of these conditions will cause the comparator 34 in FIG. 7 to change state. All reasonable audio can be eliminated, but in tests certain very large ringing signals at 12 Hz have triggered LVD 35. Ringing should only be applied while the DAA chip set is in an on-hook condition during which time the LVD 35 output is disabled, so this will not cause a problem.

The circuit described is a solution that will provide a pulse at the output if the voltage on the telecom line at the input is reduced and remains reduced for more than 200 ms typically, but can be programmed for any other reasonable delay that a customer may require. The circuit is also resistant to providing a false output when other normal telecom conditions are applied to TIP 1 and RING 2. In this, it meets the requirements in most applications where if a telephone connected in parallel to the DAA, the DAA must detect this condition and promptly cease transmission in order to free the line.

I claim:

1. A system for detecting line status of a telephone terminal in parallel with a second communications terminal at a customer's premise, the telephone and second terminal being connected to the Public Switched Telephone Network (PSTN), said system comprising:
a DC isolation barrier isolating the PSTN and the telephone from the second terminal;
means in the isolation barrier to transfer an analogue representation of voltage values received from the PSTN to a loop detection circuit; and
detection means in said loop detection circuit to detect a transition in the analogue representations having a duration greater than a selected value.

2. The system as defined in claim 1 wherein said second terminal is a Data Access Array (DAA) for interfacing data transmission equipment with the PSTN.

3. The system as defined in claim 1 wherein voltages from the PSTN are Tip and Ring voltages.

4. The system as defined in claim 3 wherein said loop detection circuit includes means to determine, from said analogue representation, polarity information respecting said Tip and Ring voltages in order to correctly orientate said line status.

5. The system as defined in claim 4 wherein said loop detection circuit includes means to detect a transition of said Tip voltage with respect to said Ring voltage.

6. The system as defined in claim 1 wherein said detection means provides an indication of a change in line status of said parallel telephone when said transition in the analogue representation has a duration greater than a selected value.

7. The system as defined in claim 6 wherein said selected value is 200 ms.

8. The system as defined in claim 6 wherein said selected value is programmable.

9. The system as defined in claim 6 wherein an indication of a change of state in line status of said parallel telephone indicates that said parallel telephone has gone off-hook.

10. The system as defined in claim 9 wherein said second terminal is caused to go on-hook upon detection that said parallel telephone has gone off-hook.

11. A system for detecting off-hook status of a telephone connected in parallel with a data transmission terminal at a customer's premise, the telephone and the data transmission terminal being connected to the Public Switched Telephone Network (PSTN), said system comprising:
a DC isolation barrier isolating the PSTN and the telephone from the data terminals connected in parallel;
means in the isolation barrier to generate an analogue representation of Tip and Ring voltage values received from the PSTN;
means to pass the analogue representation to a downstream loop detection circuit; and
detection means in said loop detection circuit to detect a transition in the analogue representation having a duration greater than a selected value wherein a transition in the analogue representation having a duration greater than said selected value indicates that said telephone has gone off-hook.

12. The system as defined in claim 11 wherein said selected value is programmable.

13. The system as defined in claim 12 wherein said selected value is 200 ms.

14. A method of detecting line status of a telephone terminal connected in parallel with a second communications terminal at a customer's premise, the telephone and second terminal being connected to the Public Switched Telephone Network (PSTN), said method comprising the steps of:
providing a DC isolation barrier isolating the PSTN and the telephone from the second terminal;
generating in the isolation barrier an analogue representation of voltage values received from the PSTN;
transferring the analogue representation to a loop detection circuit; and
detecting, in said loop detection circuit, transitions in the analogue representations having a duration greater than a selected value.

15. The method according to claim 14 wherein a transition in the analogue representation having a duration greater than said selected value indicates that said telephone has gone off-hook.

16. The method as defined in claim 15 wherein said selected value is programmable.

17. The method as defined in claim 15 wherein said selected value is 200 ms.
